(19) United States
(12) Patent Application Publication
(10) Pub. No.: US 2016/0074953 A1
(43) Pub. Date: Mar. 17, 2016

(54) METHOD FOR MODIFYING THE VALUE OF AN ELECTRIC RESISTOR COMPRISING A FERROMAGNETIC MATERIAL

(71) Applicant: CENTRE NATIONAL DE LA RECHERCHE SCIENTIFIQUE, Paris (FR)

(72) Inventors: Jean-Yves Bigot, Strasbourg (FR); Mircea Vomir, Gimgrett (FR); Michéle Albrecht, Vendenheim (FR)

(21) Appl. No.: 14/786,298

(22) PCT Filed: Apr. 18, 2014
(86) PCT No.: PCT/EP2014/058007

§ 371 Date: Oct. 22, 2015

(30) Foreign Application Priority Data
Apr. 22, 2013 (FR) 1353651

(51) Int. Cl. B23K 9/08; H01C 10/00; B23K 9/09

(52) U.S. Cl. CPC B23K 9/08; B23K 9/091; H01C 10/00

(57) ABSTRACT

A method for modifying the value of an electrical resistance (30), comprising a ferromagnetic material (31) having a first magnetization direction, comprising the following steps of: illuminating, by a first LASER beam (14), a first area (32) of the ferromagnetic material (31), so that this area is heated at a temperature equal to or higher than the Curie temperature of the ferromagnetic material (31); applying in the first area (32) a first magnetic field having a direction opposite to the first magnetization direction of the ferromagnetic material (31); reducing the energy brought by the first LASER beam (14) to the first area (32) in order to enable the first area to be cooled to form a first controlled magnetic domain (36C).

### TECHNICAL FIELD AND PRIOR ART

The invention relates to the technical field of electronics, more precisely the field of spin photonics.

In electronics, the piece of information is conveyed through electric charges. In the 1990s, research works enabled to prove that it is also possible to use the magnetic moment of electric charges, also called a spin, to code and convey information. For example, the magnetic moment of an electron can assume two opposite values referred to as “spin up” or “spin down”. This new branch of physics called spin electronics or spintronics has enabled devices using the magnetic moment of electrical charges to be produced. Information can for example be stored into a ferromagnetic medium, by modifying the arrangement of the magnetic domains forming it, by means of a LASER beam and of a magnetization source (U.S. Pat. No. 6,377,414B1).

A new type of variable electrical resistance, referred to as a spin valve, could also be made from a multilayer structure comprising a first ferromagnetic layer, having a greater coercitivity than a second ferromagnetic layer. The ferromagnetic layers are separated by a non-magnetic layer of a thickness thin enough to enable an antiferromagnetic coupling between the first and the second layers. The magnetic fields are preferably parallel and have an opposite direction between the first and the second layers. Applying a magnetic field at the second layer enables the direction of polarization of the magnetic field to be reversed at said layer, without modifying the one of the first layer. This way, the magnetic fields are oriented along a same direction at the facing faces of both ferromagnetic layers. Yet, the conductivity of a ferromagnetic device increases when the number of magnetic domains it includes decreases. Applying a magnetic field at the second layer of the spin valve enables the magnetic wall existing between the ferromagnetic layers to be erased, and therefore, the electric resistivity of this resistive device to be reduced.

This type of resistive device is complex and expensive to produce due to the different natures and to the particular arrangement of the layers forming it.

On the other hand, reversing the direction of the magnetic field in the second layer requires the application of an outside magnetic field of sufficient intensity, more precisely, of a greater intensity than the coercive field strength of said layer. A certain latency time is then necessary for the outside field to reach this critical value. Moreover, the multilayer device can have electrical resistance values which are limited by its structure itself. Indeed, these values are proportional to the number of ferromagnetic layers of opposite polarity forming the spin valve.

The aim of the invention is to provide a method for modifying the electrical resistance of a ferromagnetic device which would be quicker, according to a method of local optical writing on a ferromagnetic material forming said device, and enabling the value of the electrical resistance of the device to be modified at will in value ranges providing more choices.

### DISCLOSURE OF THE INVENTION

In order to resolve at least one of the previous technical problems, the invention provides a method for modifying the value of an electrical resistance, comprising a ferromagnetic material having a first magnetization direction, comprising the following steps:

a) illuminating, by a first LASER beam emitted by a first LASER source, a first area of the ferromagnetic material, the electrical resistance of the first area corresponding to a first value, the first LASER beam illuminating the first area so that this area is heated at a temperature equal to or higher than the Curie temperature of the ferromagnetic material;

b) applying in the first area, through magnetization means, a magnetic field having a direction opposite to the first magnetization direction of the ferromagnetic material, the intensity of the magnetic field being lower than the coercive field strength of the ferromagnetic material at room temperature;

c) reducing the energy brought by the first LASER beam to the first area in order to enable the first area to be cooled below the Curie temperature of the ferromagnetic material to form a first controlled magnetic domain, the value of the electrical resistance of the first controlled magnetic domain corresponding to a second value different from the first value.

The application of the magnetic field in the first area is maintained during step c) of cooling the first area below the Curie temperature of the ferromagnetic material. The magnetic field can be cancelled in the first area when the first area has a temperature lower than the Curie temperature of the ferromagnetic material.

The second value of the electrical resistance of the ferromagnetic material, in the presence of this controlled magnetic domain, is then different from the first value obtained without the controlled magnetic domain. A method according to the invention makes it advantageously possible to modify the value of the electrical resistance of a simple-structured resistive device, formed for example by a single layer of ferromagnetic material.

The Curie temperature of a ferromagnetic material corresponds to the temperature at which the material loses its spontaneous magnetization. The coercive field strength of a ferromagnetic material refers to the intensity of the magnetic field that needs to be applied to said material to magnetize it.

The electrical resistance can be connected to an electric voltage source, in order to be crossed by an electric current. The first controlled magnetic domain can then separate the electrical resistance into two parts.

Advantageously, the first controlled magnetic domain can have a linear shape and/or be perpendicular to the direction of propagation of the electric current crossing the electrical resistance, so as to modify more efficiently the conduction of electric current propagating through the electrical resistance.

After step c), a magnetic field having the same direction as the first magnetization direction of the ferromagnetic material, and an intensity greater than the coercive field strength of said material at room temperature, can be applied to erase the first controlled magnetic domain and thus modify again the value of the electrical resistance.

Following the erasure of the first controlled magnetic domain, the abovementioned steps can be reproduced in order to form a second controlled magnetic domain in the ferromagnetic material. The value of the electrical resistance of the second controlled magnetic domain can correspond to a third value different from the second value associated with the first controlled magnetic domain.

According to an alternative, step b) can be performed before step a). During step b), the first LASER beam can be displaced by displacement means in order to heat an area of the ferromagnetic material having wider dimensions than the first area. In other words, a controlled magnetic domain can be formed by at least two overlapping controlled magnetic domains produced according to ones of the above methods.

After step c), the position between the first LASER beam and the ferromagnetic material can be modified so that the first LASER beam illuminates a second area, distinct from the first area. One of the abovementioned methods can then be reproduced for the second area in order to produce a second controlled magnetic domain distinct from the first. The direction of the magnetic field formed by the above magnetization means can possibly be modified for at least two distinct chosen areas. It is thus possible to form distinct controlled magnetic domains delimiting magnetization areas of different directions. The values of the electrical resistances of thus formed controlled magnetic domains can be identical or different.

The value of the electrical resistance of a magnetic domain depends on its dimensions. For this reason, the invention enables the value of the electrical resistance of the ferromagnetic material to be modified at will by enabling magnetic domains of different shape and dimensions to be formed and/or erased. Thus, the values that the electrical resistance can assume are not limited by its structure, as is the case for example with a spin valve. The invention thus enables the value of the electrical resistance of the ferromagnetic material to be modified in ranges comprising more values.

The abovementioned demagnetization step can be locally or generally performed in the ferromagnetic material, in order to demagnetize one or more controlled or not controlled magnetic domains. This demagnetization step can be reproduced so as to modify at will the value of the electrical resistance.

One of the above methods can also comprise the following steps:

1) illuminating, by a second LASER beam, the ferromagnetic material forming the electrical resistance, the emitting wavelength of the second LASER beam being different from the one of the first LASER beam;

2) measuring the rotation of the polarization axis of the second LASER beam reflected or transmitted by the electrical resistance, in order to visualize the magnetic domains in the ferromagnetic material forming the electrical resistance.

The second LASER beam can be of the continuous or pulse type. It is preferably of the pulse type since the quantity of energy necessary to visualize the magnetic domains is then smaller. The second LASER beam can be focused at the same place as the first LASER beam.

The present application also relates to a control device able to implement an above-described method. A control device can comprise:
holding means able to hold an electrical resistance comprising a ferromagnetic material;
a first LASER source able to emit a first LASER beam at a first wavelength and oriented towards the holding means;
magnetization means able to establish a magnetic field having controlled direction and intensity near (or against or between or at the surface of) the holding means;
an operating device controlling the operation of the LASER source and of the magnetization means.

A control device can comprise an optical device enabling the first LASER beam to be focused, at the limit of its diffraction near (or against or between or at the surface of) the holding means. The magnetization means can form a magnetic field between −0.3 and 0.3 Tesla, these values depending on the ferromagnetic material used. These values are preferably lower, for example between −0.05 and +0.05 Tesla. A diffractive structure can possibly be interposed between the LASER source and the holding means so as to illuminate certain areas near (or against or between or at the surface of) the holding means. The control device can comprise displacement means to displace the area illuminated by the first LASER beam near (or against or between or at the surface of) the holding means.

The control device can also comprise an imaging device including:
a means able to emit a second LASER beam oriented towards the holding means at a wavelength different from the first LASER beam;
measurement means able to measure the rotation of the polarization axis of the second LASER beam when it is reflected or transmitted by an electrical resistance comprising a ferromagnetic material, held by the holding means, in order to visualize the magnetic domains in or on the ferromagnetic material.

The imaging device can comprise a modulator enabling the frequency of the first LASER beam to be modulated. The modulator can be synchronized with the measurement means in order to only detect the effect of the first LASER beam on the second LASER beam. The first and/or the second LASER beams can be of the pulsed type. The first and/or the second LASER beams can have a time resolution between 10⁻¹³ and 10⁻¹⁵ seconds. The measurement means can comprise an analyser, a polarizer and a photodetector or even a CCD camera.

### BRIEF DESCRIPTION OF THE DRAWINGS

Further details and characteristics of the invention will appear from the following description, made with reference to the following appended figures.

Identical, similar, or equivalent parts of the different figures bear the same reference numerals so as to facilitate switching from one figure to the other. The different parts represented in the figures are not necessarily drawn to a uniform scale, to make the figures more understandable. The reference frame (0; i; j; k) indicated in the figures consists in the orthogonal directions 0i, 0j, 0k.

FIG. 1 shows a front view of an exemplary control device according to the invention.

FIGS. 2A and 2B show a front view of alternatives of the control device shown in FIG. 1.

FIG. 3 shows a side view of an alternative of the control device shown in FIG. 1, comprising a ferromagnetic material.

FIG. 4 shows a perspective view of a method according to the invention, for modifying the electrical resistance of a ferromagnetic material.

FIG. 5 shows a first step of a method, according to the invention, for modifying the electrical resistance of a ferromagnetic material.

FIG. 6 shows a second step of a method according to the invention, for modifying the electrical resistance of a ferromagnetic material.

FIG. 7 shows a third step of a method according to the invention, for modifying the electrical resistance of a ferromagnetic material.

FIG. 8 shows a fourth step of a method according to the invention, for modifying the electrical resistance of a ferromagnetic material.

FIG. 9 shows an alternative of a method for modifying the electrical resistance of a ferromagnetic material.

FIG. 10 shows a ferromagnetic material including several controlled magnetic domains produced according to a method of the invention.

FIG. 11 shows a front view of a control device shown in FIG. 1 comprising an imaging device.

FIGS. 12A to 12C show perspective views of exemplary modulators.

FIG. 13 shows a magnetic hysteresis measurement of a ferromagnetic material.

FIG. 14 shows two images (A and B) of magnetic contrasts measured at the surface of a ferromagnetic material, comprising 4 controlled magnetic domains, produced according to a method of the invention.

FIG. 15 shows five images (A-E) of magnetic contrasts measured at the surface of a ferromagnetic material comprising 4 controlled magnetic domains, produced according to a method of the invention.

FIG. 16 shows measurements of the value of an electrical resistance, as a function of the number of the controlled magnetic domains produced according to a method of the invention.

### DETAILED DISCLOSURE OF PARTICULAR EMBODIMENTS

The aim of the present application is a method for modifying the value of an electrical resistance, comprising a ferromagnetic material having a first magnetization direction. In order to facilitate the understanding of the invention by the reader, an exemplary embodiment of a device enabling the method to be implemented, precedes an exemplary embodiment of said method. Each example is completed by alternatives which can be combined together to produce other non-explicitly mentioned alternatives.

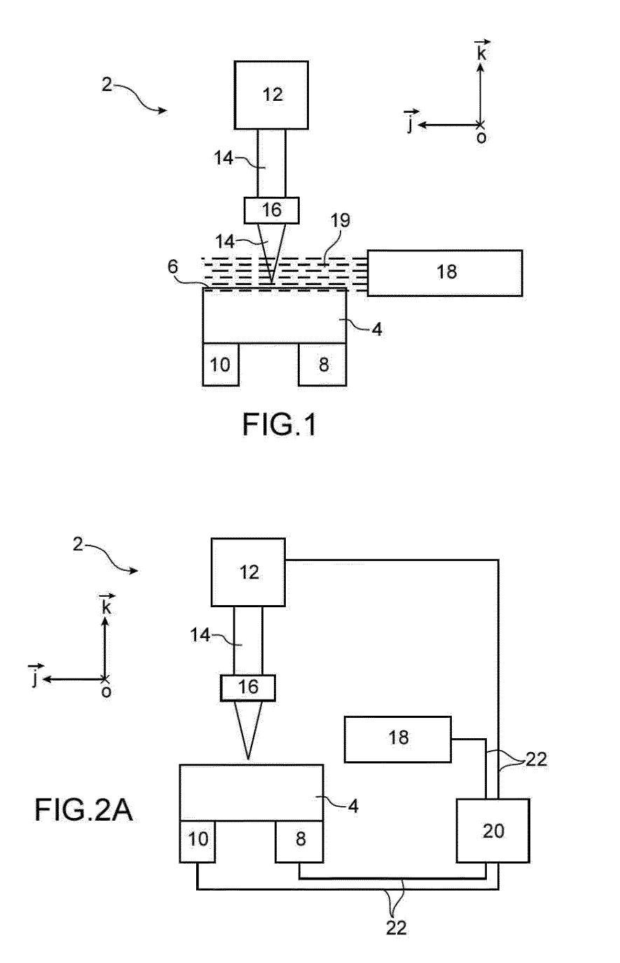

A device enabling the implementation of method according to the invention, later referred to as control device 2, comprises a holder 4 able to hold on a first face of the holder 6 an electrical resistance 30 comprising a ferromagnetic material 31. An exemplary electrical resistance 30 is described below. Preferably, the first face of the holder 6 is chosen so as to enable the electrical resistance to be optimally held on the holder 4, it can have a planar surface (FIG. 1). Displacing means are associated with the holder 4 so as to enable the displacement of the first face of the holder along a plane (0; i; j).

The displacement means comprise two independent engines 8 and 10. The first engine 8 enables the face of the holder to be displaced along a first direction (0; i), the second engine 10 along a second direction (0; j) perpendicular to the first direction. Within the present example, the holder 4 and the displacement means 8 and 10 form a high spatial resolution piezoelectric plate, sold under the reference “Physics Instrument P-733.2CD”.

The control device 2 comprises a LASER source 12 of the pulse type, emitting a LASER beam 14 at a wavelength of 400 nm with a pulse duration of about a hundred femtoseconds (1 femtosecond=10⁻¹⁵ second). The LASER source is, according to this example, a frequency-doubled enhanced titanium sapphire source. The LASER beam 14 is oriented and focused by an optical device 16 in the direction of the first face of the holder 6, so that the LASER beam is at the limit of its diffraction on said first face. The optical device is formed by a microscope lens having a numerical aperture (NA) equal to 0.6.

The control device comprises magnetization means 18 enabling a magnetic field having desired direction and intensity to be established at will on the first face of the holder 6. More precisely, the direction of the magnetic field created by the magnetization means is perpendicular to the first above defined direction and its direction can be reversed at will. The magnetization means 18 enable the formation of a static magnetic field 19 in the order of one tenth of a Tesla on the first face of the holder 6. The magnetization means can be for example formed by a cylindrical shaped NdFeB permanent magnet (diameter: 3 mm, length: 5 mm) or by an electro-magnet formed by a permanent magnet with copper wound turns powered by a current up to 6 A.

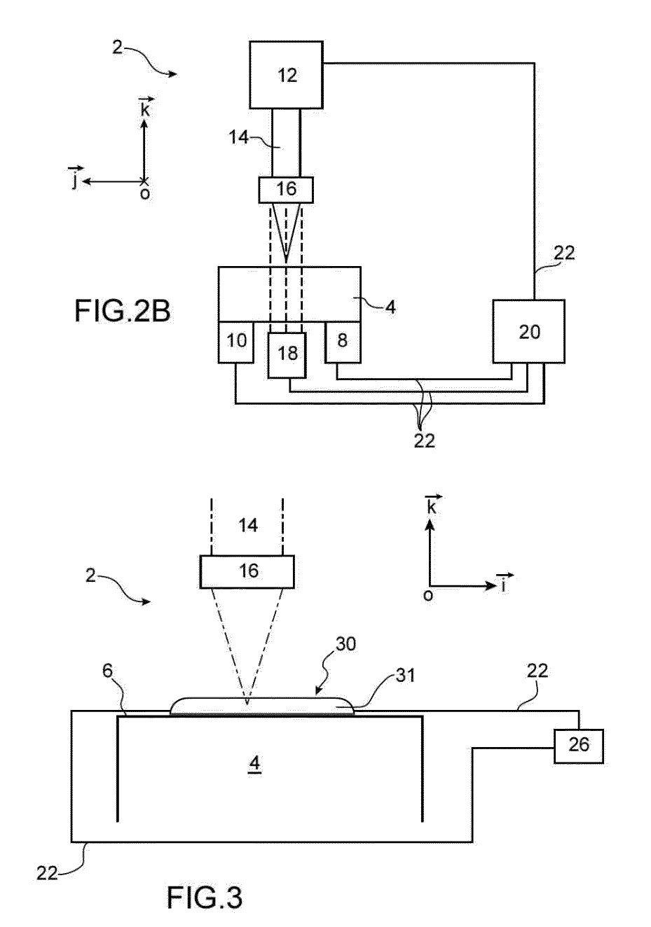

According to a first alternative of the control device 2, the displacement means 8 and 10, the LASER source 12 and the magnetization means 18, as well as the voltage source 26 are connected to a same operating device 20 enabling the operation of at least one of the previous devices to be controlled (FIG. 2A). The term “connected” refers to any means enabling an information exchange between the operating device and one of the above devices. For example, the LASER source can be connected to the operating device through one or more lead wires 22. The operating device can comprise at least one of the following means:
information saving or storing means, for example a hard disk;
computing means, for example a processor;
displaying means, for example a display;
means for interacting with the operating device, for example a numeric keyboard.

In other words, the operating device 20 can be a computer comprising a software enabling the operation of the above means to be controlled.

According to a second alternative of the control device, the magnetization means 18 are positioned so as to be able to produce a magnetic field 19 oriented to form an alpha angle relative to the axis (0; k), the value of which can be between 0 and 45° (FIG. 2B). The value of the alpha angle can be chosen as a function of the crystal anisotropy of the ferromagnetic material forming the electrical resistance positioned on the first face of the holder 6. For example, when the crystal anisotropy is perpendicular to the ferromagnetic material, that is in the direction (0; k), alpha=0° will be chosen.

According to a third alternative, the holder 4 is fixed and the displacement means are associated with the LASER source 12 so that the holder 4 is stationary and the LASER beam 14 movable relative to the first face of the holder 6.

The holder 4 and the LASER source can each possibly include displacement means, controlled by the operating device 20, so as to be movable.

According to a forth alternative, the holder 4 and the LASER source 12 may not comprise any displacement means. A mask 40, including a geometric pattern, not shown in the figures, can then be interposed between the LASER source and the optical device 16 so that the geometric pattern is imaged on the first face of the holder 6. This alternative advantageously enables magnetic domains of varied shapes and dimensions to be directly and quickly inscribed on an electrical resistance disposed on the first face of the holder 6, according to one of the methods described below.

According to a fifth alternative, when the holder 4 and the LASER source 12 do not include any displacement means, the LASER beam can be modified by having two light pulses coming from the LASER source interfere. For example, superimposing these two light pulses can vary the intensity of the LASER beam into a plane normal to its direction of propagation, to form a pattern of the Newton rings type. The advantage of this alternative is that it enables the mask provided according to the fourth alternative to be dispensed with.

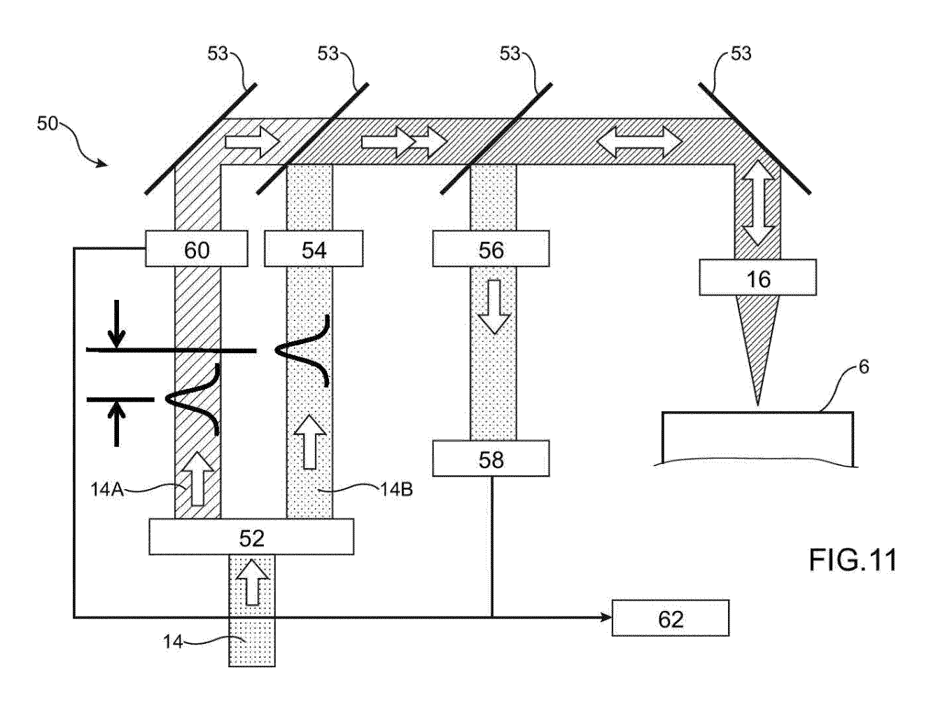

According to a sixth alternative, the control device can comprise an imaging device 50 comprising the following elements (FIG. 11). A separation means 52, made of a semi-reflecting blade, of a non-linear crystal such as BBO (beta-barium-borate) and of a means for delaying the LASER pulses, enables the LASER beam 14 to be separated into a first LASER beam 14A and a second LASER beam 14B of different wavelengths. The first LASER beam can for example have a central wavelength of 400 nm and enable controlled magnetic domains to be produced, the second LASER beam can have a wavelength of 800 nm and enable said domains to be visualized (see below). In the separation means 52, a means for delaying the LASER pulses of both beams 14A and 14B, can enable the contrast of images of the magnetic domains inscribed on the ferromagnetic material to be modified. Both LASER beams are oriented by deflection means 53 (for example reflecting or semi-reflecting blades), and focused by the microscope lens 16 into a same place on the first face of the holder 6. A polarizer 54 interposed between the separation means 52 and the first face of the holder enables the direction of polarization of the second LASER beam 14B to be determined.

An analyser 56 positioned in front of a photodetector 58 enables the measurement of the rotation of the polarization axis of at least one part of the second LASER beam 14B which is reflected or transmitted by an object (not shown) placed on the first face of the holder 6 (FIG. 11). The first and second LASER beams are of the continuous or pulse type.

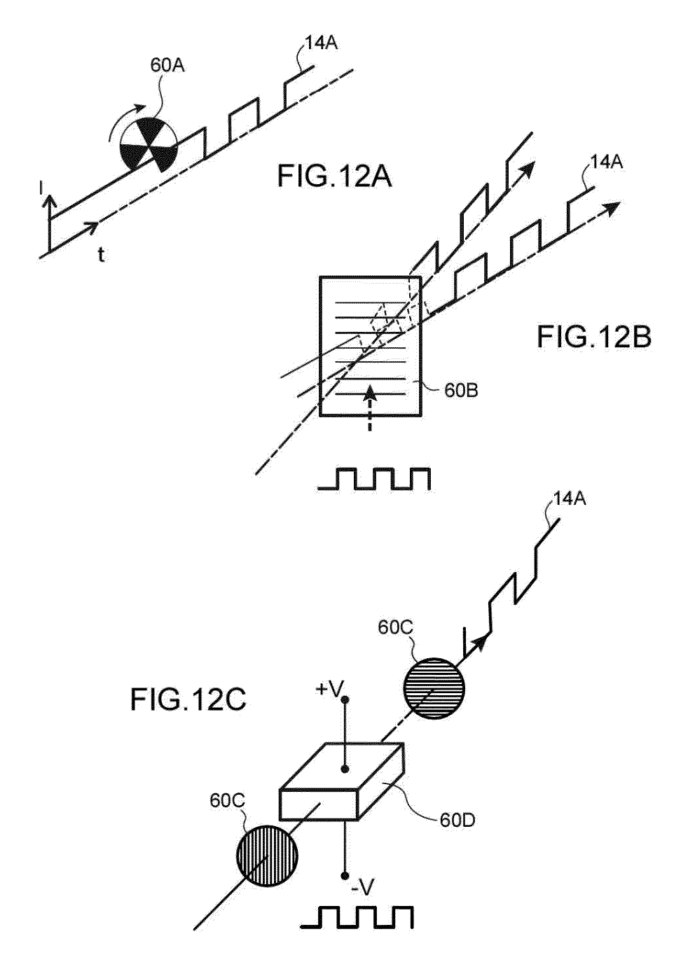

A modulator 60 can be possibly positioned between the separation means 52 and the microscope lens 16 so as to modulate the frequency of the first LASER beam 14A. The modulator 60 is synchronized with the photodetector 58 through a synchronization device 62, in order to only detect the second LASER beam 14B. The modulator 60 can be of the mechanical type and comprise a rotary propeller 60A intersecting the second LASER beam 14A (FIG. 12A). The modulator can be of the acousto-optic type 60B, comprising a crystal the refractive index variation of which, due to the acoustic waves, deflects the LASER beam, thus producing an intensity modulation (FIG. 12B). The modulator can be of the electro-optic type and comprise a Pockels cell 60D placed between two polarizers 60C (FIG. 12C).

According to an alternative, the second LASER beam 14B may not be focused by the microscope lens 16, and illuminate a wider area of the first face of the holder 6. The photodetector can then be substituted by a CCD camera advantageously enabling the image of the area illuminated by the second LASER beam 14B to be reconstructed.

The above-described imaging devices advantageously enable the magnetization variation of a ferromagnetic material placed on the first face of the holder 6 to be specially and temporally measured.

According to a seventh alternative, one of the above control device can comprise holding means for holding an electrical resistance 30 on or in contact with the first face of the holder 6. The holding means can be for example formed by two clips (not shown in the figures).

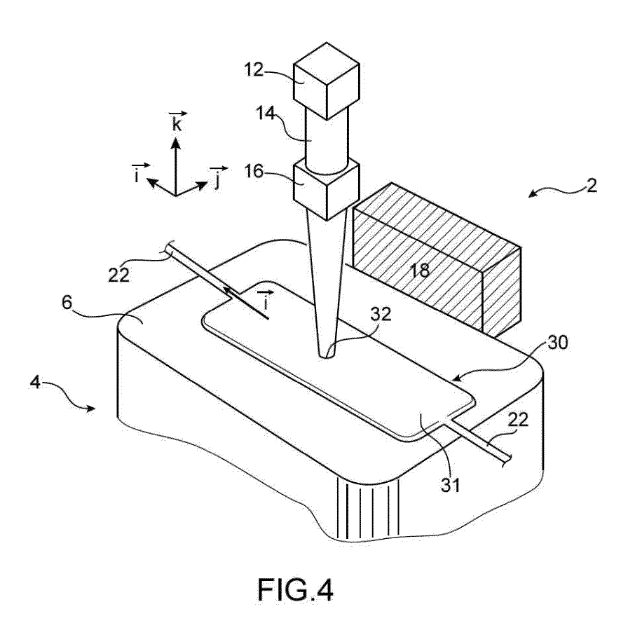

An exemplary embodiment of a method for modifying the value of an electrical resistance, comprising a ferromagnetic material having a first magnetization direction is now described. This example is implemented using an above-described control device 2 (FIG. 4).

A first step of the method consists in placing an electrical resistance 30, comprising a ferromagnetic material 31, on or in contact with the first face of the holder 6 of the control device 2. An electrical resistance 30 can be for example a Cobalt-Platinum strip with a length of 50 μm along the direction (0; i), a width of 10 μm along the direction (0; j) and a thickness of 0.01 μm along the direction (0; k) (FIG. 4). The electrical resistance is preferably electrically connected with an electric voltage source 26 through conductor traces 22, so that an electric current is able to cross the electrical resistance along the first direction (0; i) (FIG. 4).

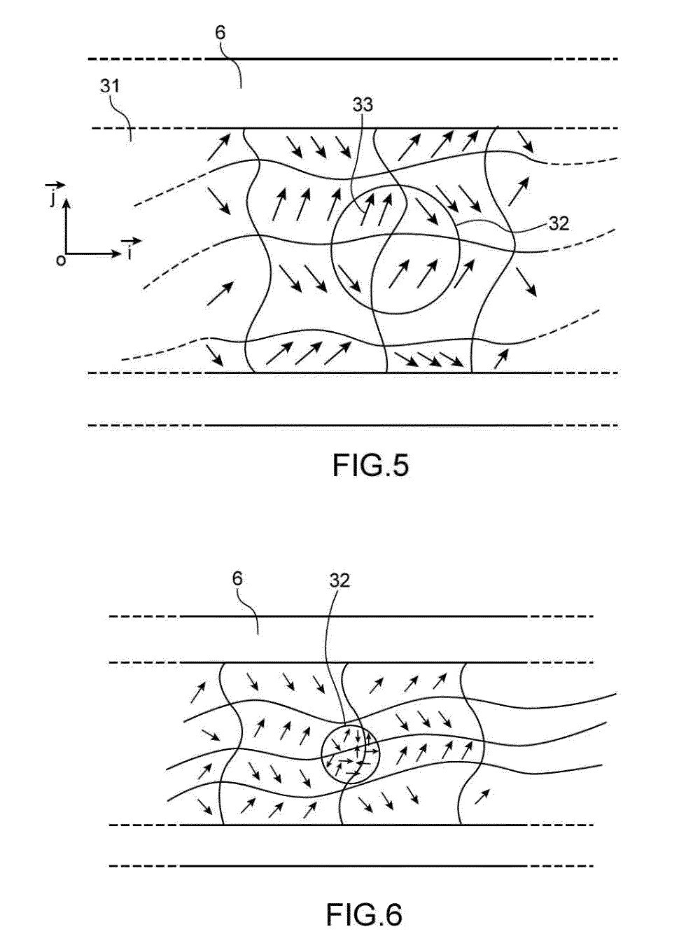

According to a second step of the method, the holder 4 and the LASER source 12 are positioned so that the LASER beam 14 is able to illuminate a chosen area 32 of the ferromagnetic material forming the electrical resistance 30 (FIG. 5).

According to a third step, the LASER source 12 is started and the LASER beam 14 is focused on the chosen area 32, so as to excite the electric charges related to the structure of the material above their Fermi energy level (1.5 eV or 3 eV) (FIG. 6). During this step, the interaction between the photons of the LASER beam 14 and the spins 33 of said electric charges, via a coupling phenomenon referred to as spin-orbit coupling, promotes an angular moment transfer between the orbital angular Lz and spin Sz moments (C. Boeglin, E. Beaurepaire, V. Halt& V. Lopez-Flores, C. Stamm, N. Pontius, H. A. Duerr, and J.-Y. Bigot, Nature, Vol. 465, 458-462, May 27, 2010). This phenomenon helps to reduce a ferromagnetic order in the area illuminated by the LASER beam (FIG. 6). The excitation density of the LASER beam is chosen so as to demagnetize the ferromagnetic material by reducing its “ferromagnetic order”. In other words, the LASER beam enables the illuminated area 32 of the ferromagnetic material 31 to be locally demagnetized. The excitation density of the LASER beam enables a temperature close to or higher than the Curie temperature of the ferromagnetic material to be reached in the chosen area. That is, an area of the material is demagnetized when the spins 33 associated with this area are hot, namely, they are at a temperature higher than the Curie temperature of the material (J.-Y. Bigot C. R. Acad. Sci. Paris, t. 2, Serie IV 2, 1483-1504 (2001)). The LASER source advantageously enables this temperature range to be reached in a few hundreds of femtoseconds.

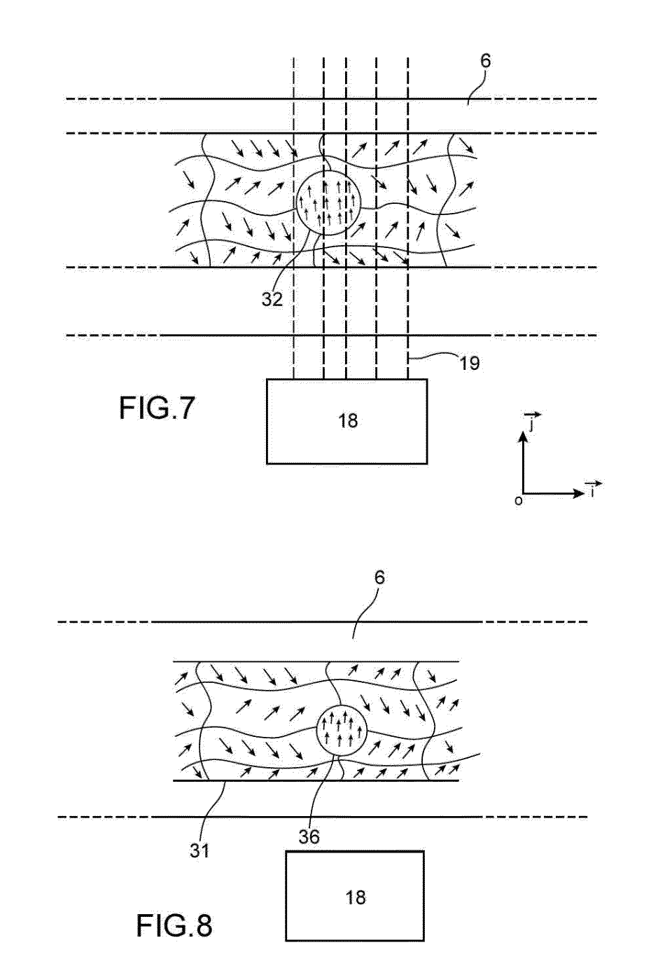

According to a fourth step of the method, when the illuminated area has a low magnetization or is demagnetized (typically the magnetization M must then be as M<(Ms/10) where Ms is the saturation magnetization of the ferromagnetic material), the magnetization means 18 apply a magnetic field 19 in the order of ±0.05 Tesla in the illuminated area 32, along the above-defined second direction (0; j) (FIG. 7). The magnetic field 19 is of sufficient intensity to orient all the hot spins of the area 32 along a same direction, but advantageously of an intensity insufficient to modify the orientation of the spins situated outside the area 32.

According to a fifth step, the magnetic field 19 being held in the illuminated area 32, the energy of the LASER beam is reduced in said area 32 so as to enable the hot spins to be cooled via a spin-phonon relaxation phenomenon. It is during this process, which lasts a few picoseconds, that the magnetization initiates its reversal dynamics. The magnetic field 19 advantageously enables the magnetic moments of the hot spins to be held along a desired direction during their cooling, in the present case along the second direction (0; j). When the temperature of the hot spins falls below the Curie temperature of the ferromagnetic material 31, the former get immobilized along the direction of the magnetic field 19 produced by the magnetization means 18.

According to a sixth step, the magnetic field 19 is cancelled in the area 32 when the spins in the area 32 have a temperature lower than the Curie temperature (FIG. 8). A magnetic domain the dimensions of which are controlled, referred to as a controlled magnetic domain 36 is then obtained.

According to a first alternative, the magnetic field 19 can be held at a constant intensity before and after focusing the LASER beam 14 on the ferromagnetic material 31. The intensity of the magnetic field 19 is preferably chosen so as not to modify the magnetic domains situated in the areas not illuminated by the LASER beam.

According to a second alternative, the distance between the LASER source 12 and the ferromagnetic material 31 and/or the optical device 16 can be modified so as to control the position of the focusing point of the LASER beam in and/or the ferromagnetic material. In other words, it is possible to accurately define the dimensions and the depth of the area 32 and therefore the formed controlled magnetic domain 36, by modifying the position of the focusing point of the LASER beam in or on the ferromagnetic material 31.

According to a third alternative, the LASER source and/or the face of the holder 6 can be displaced by the displacement means 8 and 10 so as to modify the position of the area 32 corresponding to the spot of the LASER beam on the ferromagnetic material 31. This way, it is advantageously possible to produce a controlled magnetic domain having dimensions larger than the area 32 illuminated by the LASER beam 14 and/or for this area to have a different shape.

The above-described methods for producing a controlled magnetic domain 36 advantageously enable the dimensions of said domain to be controlled. These dimensions especially depend on the volume of matter of the ferromagnetic material 31, brought by the LASER beam 14 at a temperature higher than the Curie temperature of said material. The magnetic walls present in this volume of matter are then erased. Yet, the electrical resistance of a ferromagnetic material depends on the number of magnetic walls crossed by an electric current. As a result, by erasing magnetic walls in a controlled magnetic domain, the value of the electrical resistance of the ferromagnetic material 31 is modified.

According to a fourth alternative, the LASER beam may not illuminate the ferromagnetic material when the displacement means are actuated, so as to be able to produce several distinct controlled magnetic domains 36 in a same ferromagnetic material. For example, distinct controlled magnetic domains 36A, 36B, and 36C may form lines parallel and perpendicular to the direction of propagation of the current i (FIG. 9). The distance between the lines and the magnetization direction of each line can both be controlled for example through the above displacement means, LASER, and magnetization means. By forming several distinct controlled magnetic domains, the value of the electrical resistance can advantageously be modified.

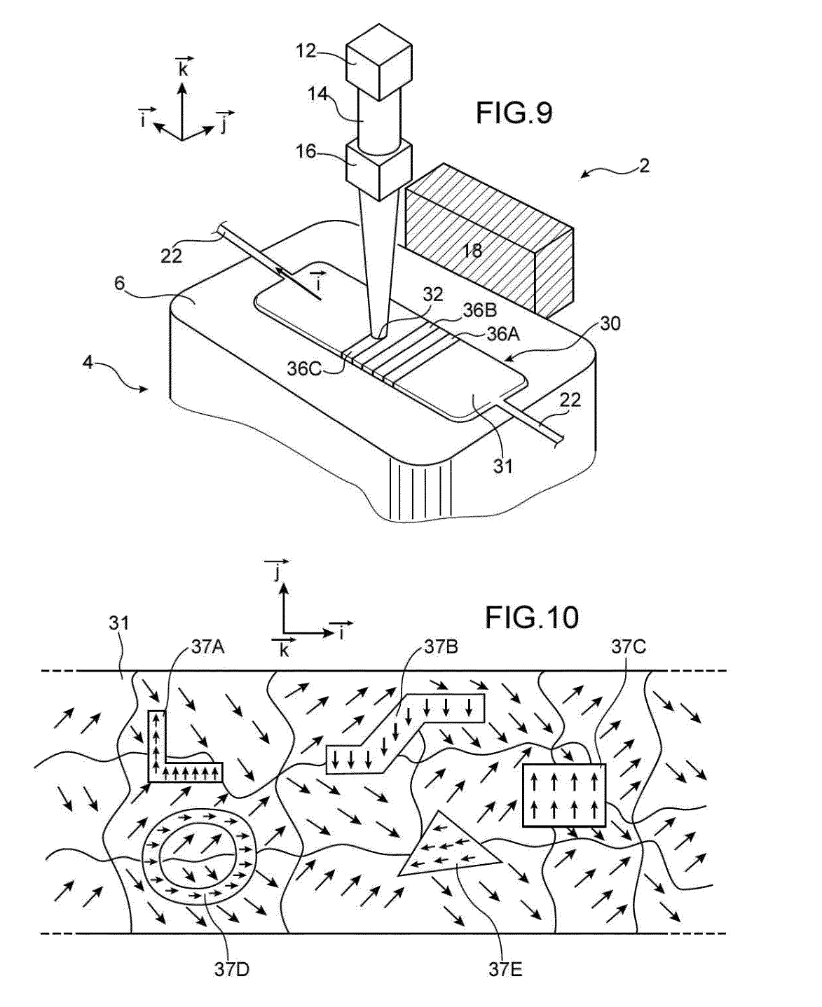

According to a fifth alternative, for each distinct controlled magnetic domain 36, the orientation of the magnetic field 19 can be modified so as to produce controlled magnetic domains 37 having different shape, dimensions, and magnetic orientation (FIG. 10).

Advantageously, the invention also includes a step for erasing one or more controlled magnetic domains. To do this, the value of the magnetic field 19 formed by the magnetization means 18 can be increased beyond the value of the coercive field strength at room temperature of the ferromagnetic material forming the electrical resistance. According to an alternative, focusing the LASER beam 14 may enable one or more controlled magnetic domains to be locally erased by heating them at a temperature higher than the Curie temperature of the ferromagnetic material. One or more new controlled magnetic domains can then be formed again on and/or in the electrical resistance 31.

According to an above-described method for modifying the value of an electrical resistance, several distinct controlled magnetic domains 36A to 36D are formed in an electrical resistance 30 comprising a ferromagnetic material 31 (FIG. 9).

The invention also relates to an imaging method, for imaging at least one controlled magnetic domain produced according to one of the above methods. To do so, a control device comprising a previously described imaging device 50 is used (FIG. 11). The imaging method according to the invention includes a first step of focusing the second LASER beam 14B, polarized by the polarizer 54, at the same place as the first LASER beam 14A, on the electrical resistance 30 held on the first face of the holder 6. A second step consists in measuring the rotation of the polarization axis of the second LASER beam 14B which is reflected or transmitted by the electrical resistance 30, using the polarizer 54, the analyser 56, and the photodetector 58 (A. Laraoui, M. Albrecht, and J. Y. Bigot, Optics Letters, Vol. 32, N^{o} 8, 936-938, Apr. 15, 2007). The first and second LASER beams can be of the continuous or pulse type. In both case, the magneto-optical signal measured by the photodetector 58 expresses the magnetization variation of the ferromagnetic material 31 and thus enables the image of the controlled magnetic domains to be obtained. In the case where both beams are of the continuous type, the physical mechanism of magnetization variation comes from an overheating of the ferromagnetic material according to the Curie-Weiss curve. In the case where both beams are of the pulse type, the measured magneto-optical signal corresponds to the spins dynamics to which a time-dependent temperature of spins which is not equal to the one of the non-illuminated ferromagnetic material can be matched. The contrast of the magnetic image of the electrical resistance depends on the delay between both LASER beams when they are of a pulse type. The rotation of the polarization axis of the LASER beam 14B depending on the delay between the LASER beams 14A and 14B (E. Beaurepaire, J.-C. Merle, A. Daunois, and J.-Y. Bigot, Phys. Rev. Lett, N^{o} 76, 4250-4253, May 27, 1996), the result is a change in the image contrast. Moreover, as the demagnetization process, observed via the value of the rotation of the polarization axis of the LASER beam 14B, depends on the instantaneous energy density (energy per surface and time unit) of the LASER beam 14A (and not on its mean power), the energy brought by the first beam in the ferromagnetic material 31 is much lower relative to the use of continuous type LASER beams, since the duration of the pulses is very short. As a result, the energy necessary to produce and identify controlled magnetic domains in the electrical resistance 30 is lower during the use of pulse type LASER beams.

The image of one or more controlled magnetic domains can possibly be obtained by displacing the first and the second LASER beams relative to the electrical resistance 30 by the displacement means (8, 10) (FIGS. 2A and 2B). The photodetector 58 can thus reconstruct point by point an image of the controlled magnetic domain(s) 36 present in the electrical resistance 30. An alternative may consist in not focusing the second LASER beam 14B to illuminate a larger area of the electrical resistance. The electrical resistance is then imaged using a CCD camera (substituted for the photodetector 58). The CCD camera enables a general reconstruction of an image of the controlled magnetic domain(s) belonging to the electrical resistance 30.

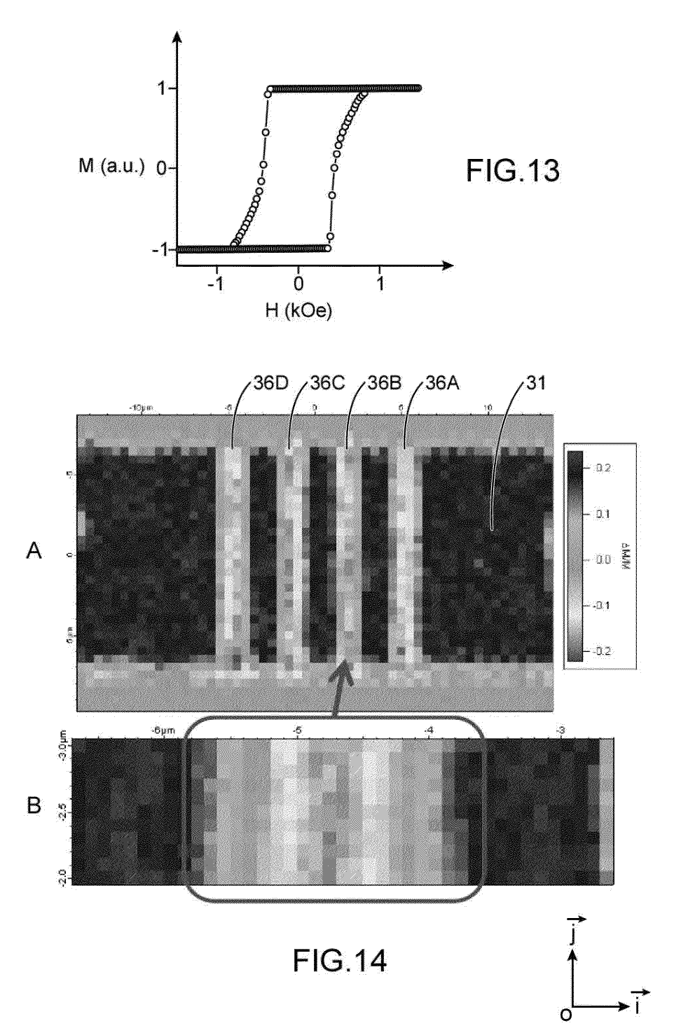

Now, several measurements for characterizing an electrical resistance 30, comprising a ferromagnetic material 31, are presented thereafter. FIG. 13 shows a magnetic hysteresis measurement of the ferromagnetic material 30 with a coercive field strength of 550×10⁻⁴ Tesla. After producing controlled magnetic domains 36A to 36D in an electrical resistance 30, according to one of the previously described methods (FIG. 9), a first series of measurements is performed using an above-described imaging device 50 (FIG. 11). More precisely, the second LASER beam 14B is of the pulse type with a spatial resolution of 333 nm and a time resolution of 150 fs. The performed measurements are shown in FIG. 14 by images A and B. Advantageously, these images can be made under the conditions of low LASER excitation; as a result, the controlled magnetic domains are not disrupted when they are visualized or read and the magnetic contrast is highly significant, for example in the order of 0.2. Images A and B have been obtained for a delay between the pulse of the LASER beam 14A and the pulse of the LASER beam 14B of 500 fs. On image A, the intensity variation of the magnetic field which is perpendicular to the first face of the holder 6 can be observed. The presence of the 4 distinct controlled magnetic domains 36A to 36D can be distinguished. Image B is an enlargement of image A of the controlled magnetic domain 36B.

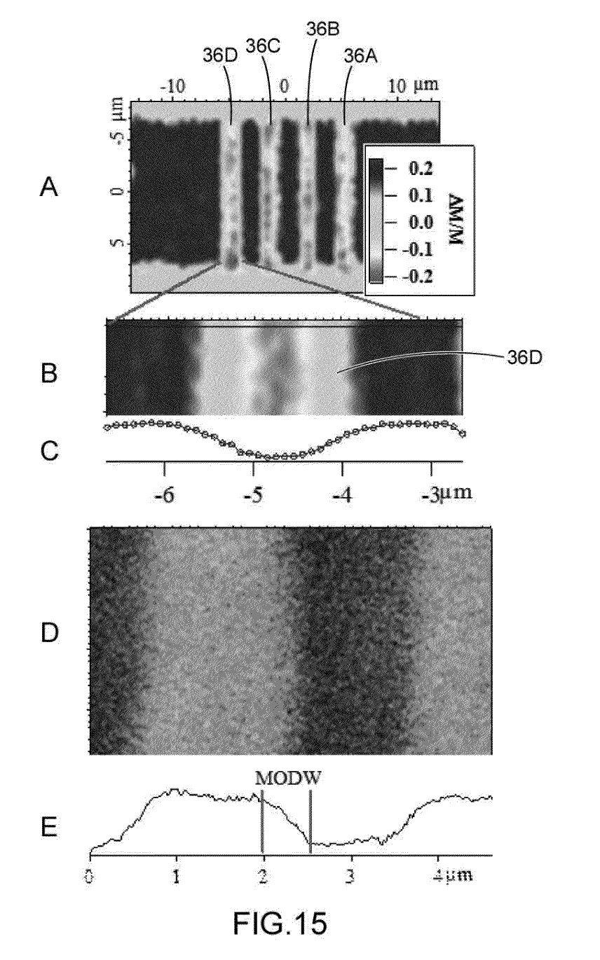

A second series of measurements is performed again on the 4 distinct controlled magnetic domains, by a technique of magnetic force microscopy (MFM) (Y. Martin and H. K. Wickramasinghe Appl. Phys. Lett. 50, 1455-1457, Mar. 19, 1987). These MFM measurements enable an image (FIG. 15D) of the controlled magnetic domains to be obtained with a better resolution than those optically obtained (FIGS. 15A and 15B). These MFM measurements are shown in FIG. 15D which corresponds to the magnetization variation in the magnetic domains 36D and 36C. FIGS. 15C) and 15E) show magnetization profiles of the controlled magnetic domains 36D optically obtained (FIG. 15B) and obtained by MFM (FIG. 15D).

From the measurements shown in FIGS. 14 and 15, the inventors have measured the width of the controlled magnetic domains, the latter being in the order of 1.1±0.2 μm and the spacing between the facing magnetic domains being in the order of 3±0.2 μm. More precisely, the width of a magnetic wall delimiting two magnetic domains is in the order of 0.5±0.2 μm. It is noteworthy to observe that the widths of the magnetic walls inscribed in the ferromagnetic material 30 have a much greater thickness relative to the usual values for this type of material. Indeed, the widths of the magnetic walls intrinsic to this type of materials (Bloch or Neel walls) are usually between 10 and 50 nm.

Measurements of the ohmic resistance of the magnetic material 30, as a function of the number of distinct controlled magnetic domains it includes, have also been performed by the inventors. The controlled magnetic domains are produced in the form of the lines shown in FIGS. 14 and 15 and according to the method of use of the control device shown in FIG. 9. The magnetization of two adjacent controlled magnetic domains is opposite. These controlled magnetic domains are transverse relative to the direction of the current propagating along the first direction (0; i) in the ferromagnetic material 31. The measurements of the ohmic resistance are made near (or against or between or on the surface of) the holding means 24 by a suitable measurement device (not shown). These measurements are performed with a current ramp the sequence of which is: 0→100 μA→0 A→−100 μA→0 A, with a pitch of 20 μA and a constant of integration of 200 ms by point of measurement.

This current examination makes it possible to check that there is no artefact such as a hysteresis, due for example to the connectics of the measurement device. The inventors have observed no such hysteresis behaviour and the measured resistances do have an ohmic type. Between each measurement, the N controlled magnetic domains are erased according to an above method and re-inscribed with a new additional controlled magnetic domain so that the ferromagnetic material includes N+1 controlled magnetic domains. Measurements of the ohmic resistance are checked between N and N+1 and compared to those measured between N−1 and N, so as to eliminate any systematic measurement error.

These measurements are also performed on a ferromagnetic material which is different from the previous material, by its length, which is twice longer, that is in the order of 80 μm.

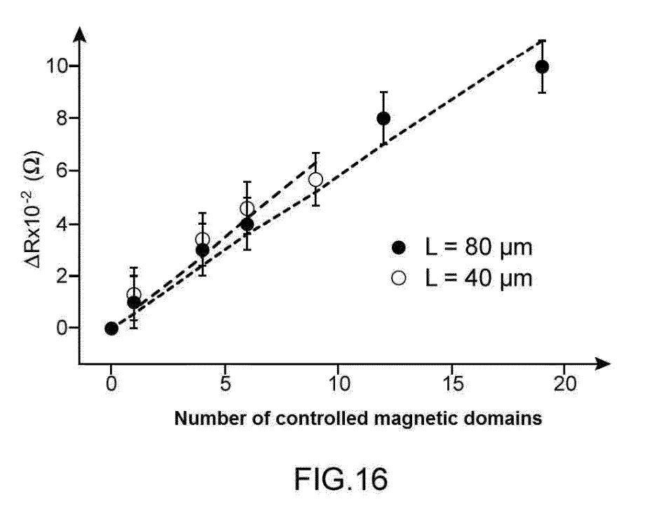

FIG. 16 shows the measurements of the ohmic resistance variation ΔR=R_{N}−R₀ where R_{N} represents the ohmic resistance of the ferromagnetic material including N distinct magnetic domains and R₀ is the same measurement when the magnetic material does not include any controlled magnetic domain. Measurements of the ohmic resistance are performed in the absence of a magnetic field 19 produced by the magnetization means 18. The value of R₀ is respectively 104Ω and 257Ω for a magnetic material of a length of 40 μm and 80 μm. FIG. 16 shows this ohmic resistance variation of the ferromagnetic material for these two lengths and as a function of the number of controlled magnetic domains produced according to an above-described method. These measurements clearly prove that the ohmic resistance variation of the ferromagnetic material increases with the number of produced controlled magnetic domains. The invention therefore enables to vary the ohmic resistance of the magnetic material 31 in a controlled and accurate way. It is to be noted that the value of the ohmic resistance can vary nearly continuously, by adapting the number and the dimensions of the controlled magnetic domains as a function of the desired resistance value.

For the performances of electric conductivity of a material, the significant quantity is the relative variation of the electric resistivity defined with respect to a single magnetic wall (P):

$${( Δ R / R )}_{P , i} = \frac{Δ {R}_{P}}{2 {R}_{i}} \frac{{L}_{i}}{{d}_{P}} \qquad Equation 1$$

Ri is the resistance of the ferromagnetic material, Lᵢ its length, dₚ the width of a controlled magnetic wall and ΔRₚ is the resistance measurement itself of the magnetic wall (P). From the above performed measurements, the inventors have computed a relative variation value of the resistivity equal to 1.6×10⁻³. This value is in the order of magnitude of those obtained with usual structures, that is, non-controlled magnetic walls which are intrinsic to the ferromagnetic material.

The inventors have noticed that the controlled magnetic domains are stable at room temperature (in the order of 20° C.) and that the above producing methods work at this temperature. The resistance relative variation is low but it is absolutely reliable, given the excellent signal-to-noise ratio equal to 10⁵ (FIG. 16).

To conclude, the present application provides a method for modifying the value of a simple structure ferromagnetic resistive device which is inexpensive to manufacture. Magnetic domains having controlled shape, dimensions, and magnetic orientation can be formed and erased according to very high repetition rates, especially compatible with the optic communication devices. Another advantage of the invention lays in the possibility of modifying the value of the resistive device independently of its structure, according to continuous value ranges which can be adapted to the operating conditions.

What is claimed is:

1-15. (canceled)

16. A method for modifying the value of an electrical resistance, comprising a ferromagnetic material having a first magnetization direction, comprising the following steps:
a) illuminating, by a first LASER beam emitted by a first LASER source, a first area of the ferromagnetic material, the electrical resistance of the first area corresponding to a first value, the first LASER beam illuminating the first area so that this area is heated at a temperature equal to or higher than the Curie temperature of the ferromagnetic material;
b) applying in the first area, a magnetic field having a direction opposite the first magnetization direction of the ferromagnetic material, the intensity of the magnetic field being lower than the coercive field strength of the ferromagnetic material at room temperature;
c) reducing the energy brought by the first LASER beam to the first area in order to enable the first area to be cooled below the Curie temperature of the ferromagnetic material to form a first controlled magnetic domain, the value of the electrical resistance of the first controlled magnetic domain corresponding to a second value different from the first value.

17. A method for modifying the value of an electrical resistance according to claim 16, wherein the electrical resistance is connected to an electric voltage source in order to be crossed by an electric current.

18. A method for modifying the value of an electrical resistance according to claim 17, wherein the first controlled magnetic domain is formed to separate the electrical resistance into two parts.

19. A method for modifying the value of an electrical resistance according to claim 18, wherein the first controlled magnetic domain has a linear shape and is perpendicular to the direction of propagation of the electric current crossing the electrical resistance.

20. A method for modifying the value of an electrical resistance according to claim 16, wherein, after step c), a magnetic field having the same direction as the first magnetization direction of the ferromagnetic material and an intensity greater than the coercive field strength of said material, is applied to erase the first controlled magnetic domain, in order to modify the value of the electrical resistance.

21. The method for modifying the value of an electrical resistance according to claim 20, wherein, after erasure of the first controlled magnetic domain, a second controlled magnetic domain is formed according to the following steps:
a1) illuminating, by the first LASER beam, the first area of the ferromagnetic material, the first LASER beam illuminating the first area so that this area is heated at a temperature equal to or higher than the Curie temperature of the ferromagnetic material;
b1) applying in the first area, a magnetic field having a direction opposite the first magnetization direction of the ferromagnetic material, the intensity of the magnetic field being lower than the coercive field strength of the ferromagnetic material at room temperature;
c1) reducing the energy brought by the first LASER beam to the first area in order to enable the first area to be cooled below the Curie temperature of the ferromagnetic material to form the second controlled magnetic domain, the value of the electrical resistance of the second controlled magnetic domain corresponding to a third value different from the second value.

22. The method for modifying the value of an electrical resistance according to claim 21, wherein, the value of the electrical resistance of the second controlled magnetic domain corresponds to a third value which is different from the second value associated with the first controlled magnetic domain.

23. The method for modifying the value of an electrical resistance according to claim 16, wherein step b) is performed before step a).

24. The method for modifying the value of an electrical resistance according to claim 16, wherein during step b), the first LASER beam is displaced on the ferromagnetic material in order to heat an area having wider dimensions than the first area.

25. The method for modifying the value of an electrical resistance according to claim 16, wherein after step c), a second controlled magnetic domain is formed according to the following steps:
a2) the position between the first LASER beam and the ferromagnetic material is modified so that the first LASER beam illuminates a second area, distinct from the first area, so that this area is heated at a temperature equal to or higher than the Curie temperature of the ferromagnetic material in the second area so as to produce a second controlled magnetic domain distinct from the first.
b2) applying in the second area, a magnetic field having a direction opposite the first magnetization direction of the ferromagnetic material, the intensity of the magnetic field being lower than the coercive field strength of the ferromagnetic material at room temperature;
c2) reducing the energy brought by the first LASER beam to the second area in order to enable the second area to be cooled below the Curie temperature of the ferromagnetic material to form the second controlled magnetic domain distinct from the first, the value of the electrical resistance of the second controlled magnetic domain corresponding to a third value different from the second value.

26. The method for modifying the value of an electrical resistance according to claim 16, comprising the following steps of:
1) illuminating, by a second LASER beam, the ferromagnetic material forming the electrical resistance, the emitting wavelength of the second LASER beam being different from the one of the first LASER beam;
2) measuring the rotation of the polarization axis of the second LASER beam reflected or transmitted by the electrical resistance, in order to visualize the magnetic domains in the ferromagnetic material.

27. The method for modifying the value of an electrical resistance according to claim 26, wherein the first and the second LASER beams are of the pulse type.

28. A control device for implementing a method for modifying the value of an electrical resistance according to claim 16, comprising:
a holder able to hold the electrical resistance;
a first LASER source able to emit a first LASER beam at a first wavelength and oriented towards the holding means;
a magnet for establishing a magnetic field having controlled direction and intensity near the holder;
an operating device controlling the operation of the LASER source and of the magnetization means.

29. A control device according to claim 28, comprising a first and a second engine for displacing the area illuminated by the first LASER beam on the ferromagnetic material, in order to heat an area having wider dimensions than the first area.

30. The control device according to claim 28, comprising an imaging device including:
a semi-reflecting blade and a non-linear crystal arranged so that the LASER beam, emitted by the first laser source, is separated into the first laser beam and a second LASER beam, said second LASER is oriented towards the holder at a wavelength different from the first LASER beam;
a polarizer and an analyser arranged for measuring the rotation of the polarization axis of the second LASER beam when it is reflected or transmitted by an electrical resistance comprising a ferromagnetic material, held by the holder, in order to visualize the magnetic domains in the ferromagnetic material.

31. The control device according to claim 28, comprising an imaging device including:
a means able to emit a second LASER beam oriented towards the holder at a wavelength different from the first LASER beam;
measurement means able to measure the rotation of the polarization axis of the second LASER beam when it is reflected or transmitted by an electrical resistance comprising a ferromagnetic material, held by the holder, in order to visualize the magnetic domains in the ferromagnetic material.
